(19) United States
(12) Patent Application Publication
(10) Pub. No.: US 2016/0236811 A1
(43) Pub. Date: Aug. 18, 2016

(54) RETAIL BOXES AND METHOD OF MANUFACTURING RETAIL BOXES

(71) Applicant: Jarl Jensen, Nyack, NY (US)

(72) Inventor: Jarl Jensen, Nyack, NY (US)

(21) Appl. No.: 15/050,213

(22) Filed: Feb. 22, 2016

Related U.S. Application Data
(63) Continuation-in-part of application No. 13/234,728, filed on Sep. 16, 2011, now Pat. No. 9,266,640.
Application No. 13/234,728 is a continuation-in-part of application No. 12/463,883, filed on May 11, 2009, now Pat. No. 8,037,663.
(60) Provisional application No. 61/080,237, filed on Jul. 12, 2008.
(60) Provisional application No. 62/242,989, filed on Oct. 16, 2015.
(60) Provisional application No. 62/183,865, filed on Jun. 24, 2015.
(60) Provisional application No. 62/153,437, filed on Apr. 27, 2015.
(60) Provisional application No. 62/132,750, filed on Mar. 13, 2015.

(51) Int. Cl. B65D 5/32; B31B 17/00; B65D 5/42

(52) U.S. Cl. CPC B65D 5/324; B65D 5/4279; B31B 17/00; B31B 2217/0038

(57) ABSTRACT

The present disclosure is directed to a retail box and a method of making a retail box. Retail boxes in accordance with the present disclosure can be manufactured to include an insert to substantially strengthen the retail box.

### CROSS REFERENCE TO RELATED APPLICATIONS

This application is a continuation-in-part of U.S. patent application Ser. No. 13/234,728, filed on Sep. 16, 2011, which is a continuation-in-part of U.S. patent application Ser. No. 12/463,883 filed May 11, 2009 which has issued as U.S. Pat. No. 8,037,663 on Oct. 18, 2011, which claims the benefit of U.S. Provisional Patent Application Ser. No. 61/080,237 filed on Jul. 12, 2008, the entire disclosures of which are hereby incorporated herein by reference. This application also claims priority under 35 U.S.C. §119(e) to U.S. Patent Application No. 62/132,750 filed on Mar. 13, 2015, the entire disclosure of which is hereby incorporated herein by reference. This application also claims priority under 35 U.S.C. §119(e) to U.S. Patent Application No. 62/153,437 filed on Apr. 27, 2015, the entire disclosure of which is hereby incorporated herein by reference. This application also claims priority under 35 U.S.C. §119(e) to U.S. Patent Application No. 62/183,865 filed on Jun. 24, 2015, the entire disclosure of which is hereby incorporated herein by reference. This application also claims priority under 35 U.S.C. §119(e) to U.S. Patent Application No. 62/242,989 filed on Oct. 16, 2015, the entire disclosure of which is hereby incorporated herein by reference.

### FIELD

The present disclosure is related to retail boxes and machinery and methods for making retail boxes.

### BACKGROUND

Retail boxes are used widely by companies and individuals to package retail items for shipping to customers. Typically, the manufacture and assembly of a retail box is divided between two processes or machines that may be associated with different service providers or companies. Specifically, a retail box is first manufactured from raw materials, such as cardboard. This manufacturing process or step may occur using a dedicated machine that may be associated with a dedicated plant or company, which provides this service or manufacturing step. Secondly, the retail box is opened or assembled into a usable configuration. This step may be performed by a second dedicated machine, which may be located at a separate facility from the facility that had manufactured the retail box. This two-step process can lead to inefficiencies and added costs that may be born by companies or individuals who purchase a retail box.

Retail boxes are generally sold in an assembled condition. A purchaser of a retail box will typically purchase a particular quantity of retail boxes, which remain on hand for use in shipping. As can be appreciated, a company that ships a large volume of retail items may require a large inventory of retail boxes to be on hand to meet the needs of shipping various retail items. Maintaining a large inventory of retail boxes can have disadvantages, such as the need to pay taxes on the maintained inventory and space requirements associated with storing the quantity of retail boxes. Additionally, standard retail boxes are damaged easily when impacted by crumbling or tearing.

Containers for products that require protection from moisture generally include a moisture barrier component and a structured support component. For example, products such as cereal and printer cartridges are often packaged in a two part container that includes an inner, moisture impermeable bag, that is held within an outer cardboard box. As another example, cookies and crackers are often held in a plastic tray that is in turn placed in a moisture impermeable bag. Because these containers are formed from multiple parts, they are relatively expensive. In addition, they often incorporate non-renewable materials and can be difficult or impossible to recycle.

Accordingly, it would be desirable to have a system and method for manufacturing retail boxes that combine the manufacture and opening and/or assembly of the boxes together in one process. Additionally, it would be desirable to have a system and method of making retail boxes that allows retail boxes to be manufactured at the point of use; therefore, reducing the quantity of retail boxes that need to be maintained as inventory or substantially eliminating the need to maintain an inventory of boxes, thereby making available resources to more productive activities. Additionally, it would be desirable to have a system and method for manufacturing retail boxes that produces boxes that are more resilient to impact, having glued flaps that are able to bend or recoil and fully recover from impacts. Additionally, it would be desirable to have a system and method for manufacturing retail boxes where the box is made from substrate that is inline printable, allowing custom printing to be performed during manufacture of the box, leading to faster time to market. Additionally, it would be desirable to have a system and method for manufacturing retail boxes where the box is made from a substrate that is substantially thinner than materials used to make current retail boxes, which is a desirable economic and ecological feature. It would also be desirable to have a system and a method for providing boxes that incorporates a moisture impermeable barrier, without requiring multiple components, and/or without being formed from non-renewable materials.

### SUMMARY

The present disclosure is directed to a system and method for manufacturing retail boxes. The disclosed invention is operable to produce a retail box from paper, which is rolled on a core or provided in sheet form. The paper can include a moisture impermeable barrier or layer. Initially, a top and a bottom of the box are produced. The two halves of the box are interconnected. In accordance with at least some embodiments, gaps between the two halves of the box and in particular at the corners of the box can be sealed with a sealant, to provide a container or volume that is entirely or substantially impermeable to moisture. For each of the top and bottom half of the box, a portion of paper that is output from paper rolled on a core or a sheet or a section of a sheet is applied.

In one embodiment, each of the top and the bottom halves are received in a folding plow, which folds the box portions into two complementary half-boxes. The two half-boxes are then brought together and glued at their respective sides. The overlapping box side portions are fully coated with glue when assembled, creating a strong composite structure. In one embodiment, tension is maintained on the assembled box structure and paper webbing in the direction of the webbing throughout the process and at least until the glue substantially cures. The assembled portion is now cut to length and at least one end portion of the box remains open allowing merchandise or other items to be placed in the interior of the box. Upon cutting to length, and before placing merchandise in the box, tension is applied to the assembled box in a direction substantially perpendicular to the direction of the previous tension and at a substantially right angle to the glued box side surface when the box is in an opened configuration. One of the ends may be optionally closed at this point by fully coating at least one surface of the end flaps and assembling the end flaps together. Merchandise or other items may then be placed in the box, and the remaining open box end may then be closed in a similar manner as the other end.

In another embodiment, the paper may be received in a rotary die cutting module. Here, the paper is cut into a desired shape and optionally scored and/or creased. The rotary die cutting module may cut portions of the paper webbing that will ultimately form the dust flaps, end flaps or sides of the box. After the top and bottom halves of the box have been cut and creased, the paper may then be fed into a folding plow.

In yet another embodiment, the paper webbing may be received by an inline printer. The inline printer may be used to print directly on the substrate at any point in the process.

In accordance with further embodiments of the present invention, any gaps remaining after formation of the box can be sealed. For example, gaps that may occur at the corners of a completed box can be sealed using a caulk or other gap filling substance. In accordance with still other embodiments, the glue used to adhere different portions of the box to one another in the vicinity of gaps can be provided in amounts in excess of what is required to join those portions, such that the gaps will be sealed by the glue. In accordance with still further embodiments, gaps can be covered by tape, or by adhering patch pieces over the gaps. In accordance with embodiments of the present invention, the caulk or other material used to seal gaps in a completed box can itself be moisture impermeable, and may form a moisture impermeable seal with the material of the box itself. When combined with a box material that is itself moisture impermeable, a moisture impermeable or sealed container defining a sealed volume that is moisture impermeable is created.

In accordance with embodiments of the present invention, a box formed from two cooperating half-boxes is provided. Each half-box may be formed from rolled or sheet paper or other substrate material. In accordance with further embodiments of the present invention, the paper or substrate material may be impermeable to moisture. Accordingly, the substrate or paper may comprise a coated paper, a paper or substrate incorporating a moisture impermeable film or membrane, or may be formed from moisture impermeable material. Overlapping side and end portions of the two box halves can be entirely or substantially coated with an adhesive or other bonding agent. The adhesive or bonding agent can be waterproof. In addition, dust flaps can be adhered to other dust flaps, side flaps and/or end flaps. In accordance with further embodiments of the present invention, an assembled box can include sealant on at least the corners of the box. Such sealant can, for example, silicon, epoxy, or other caulk or adhesive. The sealant at the corners of the assembled box cooperates with the moisture impermeable paper or substrate material, to form a completed box that is entirely or substantially moisture impermeable.

In accordance with embodiments of the present invention, a box can be formed containing at least one insert. The insert can overlap at least one side panel and adjacent panels. In some embodiments, more than one insert can be used. The additional inserts can be used over a second side panel, or overlapping the area between a top panel or bottom panel and an end flap. These inserts can be used alone, or in combination with other inserts. Embodiments of the invention also include methods to form and attach the insert to a box blank.

These and other features of embodiments of the disclosure can be further understood from the following description, particularly when considered in connection with the accompanying drawings.

### BRIEF DESCRIPTION OF THE DRAWINGS

FIG. 1 is a diagram showing the manufacture and assembly of a retail box, in accordance with embodiments of the present disclosure;

FIG. 2A shows a segment of paper webbing and score lines along which folds and/or cuts may be made;

FIG. 2B shows a half-box blank in accordance with embodiments of the present invention;

FIG. 2C illustrates a half-box blank in accordance with still other embodiments of the present invention;

FIG. 3A shows paper webbing as it passes through a folding plow;

FIG. 3B shows a cross-sectional view of the paper webbing after it has passed through the paper plow;

FIG. 4 shows an assembled box being engaged by rollers and a box guide;

FIG. 5 shows a cross-sectional view of an assembled box being engaged by tensioning prongs;

FIG. 6 shows a cross-sectional view of an assembled box being engaged by vacuum plates;

FIG. 7A shows a cross-sectional view of the assembly of two half-boxes in an alternate embodiment;

FIG. 7B shows a cross-sectional view of the assembly of two half-boxes in an alternate embodiment;

FIG. 8A is an illustration of an assembled box;

FIG. 8B is a cross-section of assembled boxes in accordance with embodiments of the present invention;

FIG. 8C is a cross-section of assembled boxes in accordance with embodiments of the present invention

FIG. 8D is a cross-section of assembled boxes in accordance with embodiments of the present invention;

FIG. 9 is a partial prospective view of an assembled box in accordance with embodiments of the present invention;

FIG. 10A is an illustration of a box blank;

FIG. 10B is an illustration of a side panel insert;

FIG. 11A is an illustration of the box blank with the side panel insert attached;

FIG. 11 B is a cross sectional view of the box blank and the side panel insert after lamination;

FIG. 12A is an illustration of an assembled box;

FIG. 12B is a cross sectional view of the assemble box assembly;

FIG. 13A depicts a box blank in a folded and cut state;

FIG. 13B depicts a side panel unit in a folded state;

FIG. 14A depicts a box blank in a cut state;

FIG. 14B depicts two inserts;

FIG. 14C depicts the box blank illustrated in FIG. 14A with the two inserts depicted in FIG. 14B;

FIG. 15 illustrates a process to attach the side panel inserts to the box blank;

FIG. 16 illustrates a method to attach the side panel inserts to a box blank utilizing a vacuum roller; and

FIG. 17 illustrates a folding carton with end flap inserts and side flap inserts.

### DETAILED DESCRIPTION

The present disclosure is directed to a retail box and a method of making a retail box. Retail boxes in accordance with the present disclosure are manufactured beginning with paper, which is rolled on a core, or alternatively is provided in sheet form. As used herein, a “retail box” refers to any box suitable for containing an item, for otherwise creating a desired volume, for creating a display, or for creating any other box-like structure. Two halves of the box, or “half-boxes,” are first produced, and then brought together to form a complete box. In manufacturing a retail box from rolled or sheet paper, the present disclosure allows a retail box to be manufactured and assembled at the point of use. Specifically, a shipper or retailer who requires packaging for a particular item may keep rolled paper or sheets of paper on hand, and use the paper to manufacture a box when needed.

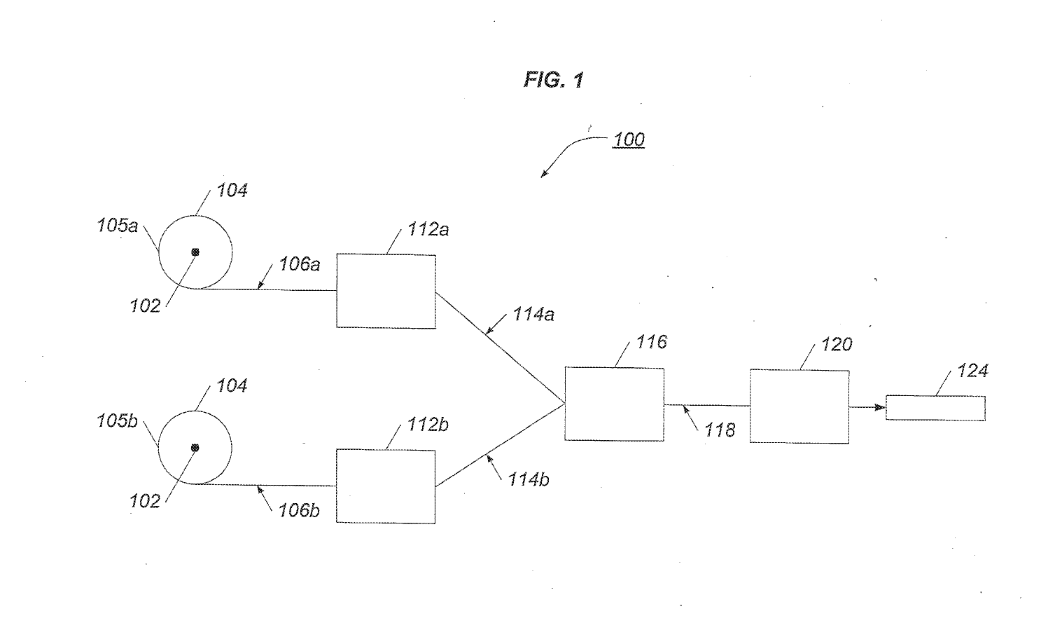

With reference to FIG. 1, a system 100 for manufacturing a retail box in accordance with embodiments of the present disclosure is depicted. In manufacturing a retail box, the present disclosure begins with one or more supplies 104 of paper or other substrate 105 material that are each rolled onto a respective core 102. For the purposes of illustration, FIG. 1 includes two paper rolls 105a and 105b to supply paper for the two half-boxes that will be used to form a completed box. As can be appreciated by one of skill in the art after consideration of the present disclosure, as an alternative, one paper roll 105, which supplies paper or paper webbing 106 for both half-boxes may be used. As an alternative to one or multiple rolls of paper 105, the paper supplies 104 may be in the form of individual sheets of paper. As a first step in manufacturing a retail box in accordance with embodiments of the present invention, paper 106 is dispensed from a paper supply 104 and received in a folding plow 112. The folding plow 112 receives the paper webbing 106 and creases and folds the paper 106, to form a half-box blank 114. The half-box blank 114 is then sent to bonding or gluing station 116 where it is joined with another half-box blank 114 to form an assembled box blank 118. The assembled box blank 118 then passes to cutting station 120, where the box blank is cut to length, producing a box 124. As shown in FIG. 1, two folding plows 112a and 112b may be provided to form half-box blanks 114a and 114b from two supplies 104 of paper 106a and 106b.

In another embodiment of the present disclosure, a rotary die cutting module may accept the paper webbing 106 before passing the webbing to the folding plow 112. The rotary die cutting module receives the paper and cuts and creases the paper to produce creases in the webbing to better enable the folding plow 112 to create creased and folded paper 114 comprising or that will comprise a half-box blank. Additionally as one having skill in the art will appreciate, the rotary die cutting module is operable to produce creases and/or cuts in the paper webbing 106 in locations that may ultimately form the dust flaps, end flaps or sides of the box. As one having skill in the art will appreciate, removal of a certain amount of material, for example, on the dust flaps resulting in a tapered flap (e.g., trapezoidal), may ease later assembly of the end flaps and dust flaps.

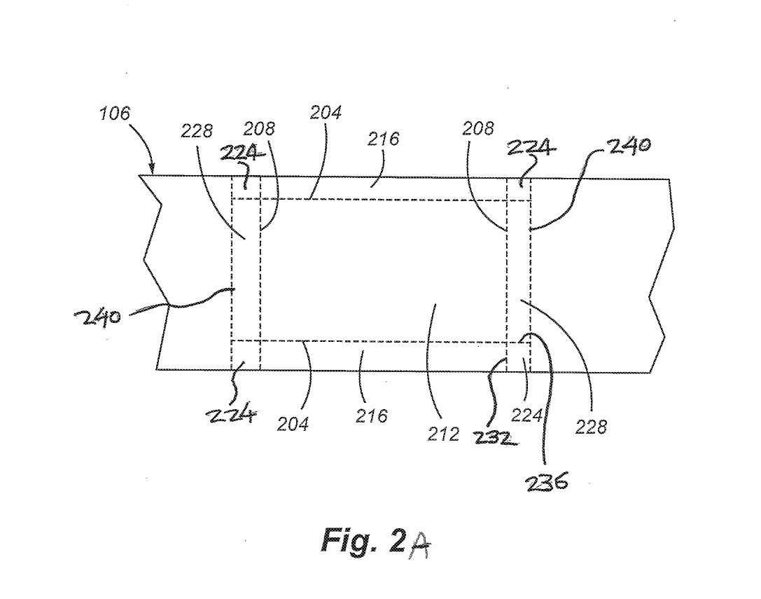

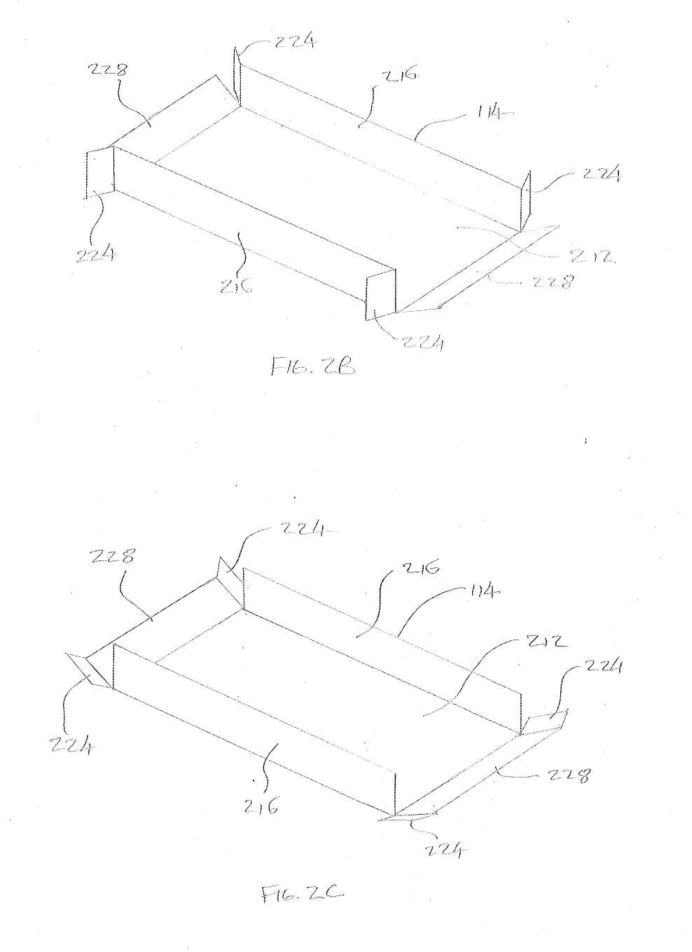

FIG. 2A shows a segment of the paper webbing 106 and illustrates the portions of the webbing that will ultimately become features of a box. More particularly, the portions of the webbing 106 between end lines 240 will become a half-box blank. Score lines 204 and 208 represent lines along which the webbing will be folded to create a central section 212, the side flaps 216, the end flaps 228 and the dust flaps 224. As is shown, the section of webbing will become a half-box having a central section 212 and four flaps, including two side flaps 216 and two end flaps 228 that depend from the central section 212. One having skill in the art will appreciate that a dust flap 224 may be cut and configured to depend from either the side flaps 216 or the end flaps 228. For example, if the segment 232 extending from one side of the paper webbing 106 to an adjacent score line 204 comprises a cut line, the dust flap 224 adjacent that cut line 232 will depend from the adjacent end flap 228. Alternatively, if a cut is formed along segment 236, extending between the end line 240 and the adjacent score line 208, the dust flap 224 will depend from the side flap 216. In one embodiment, score lines 204 and 208 may represent creases or score lines created by a rotary die module along which the folds will be created.

FIG. 2B illustrates a half-box blank 114 having dust flaps 224 that depend from side flaps 216. FIG. 2C illustrates a half-box blank 114 with dust flaps 224 that depend from end flaps 228.

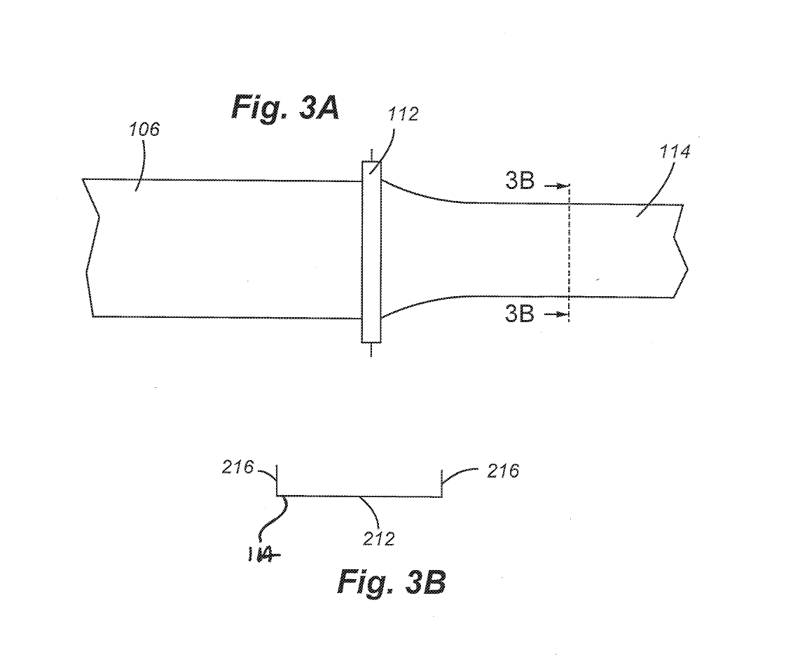

FIG. 3A shows the paper webbing 106, before and after it passes through the folding plow 112, at which point it comprises a half-box blank 114. FIG. 3B is a cross-sectional view of the half-box blank 114 after it has passed through the folding plow 112. As shown, the half-box blank 114 generally has a U-shape, and having a central section 212 and two side flaps 216 depending from either side of central section 212. Prior to joining the two half-boxes, the side flaps 216 of each half-box blank 114 can be folded by the folding plow 112 so that the side flap 216 is approximately 90 degrees with respect to the central section 212, as shown in FIG. 3B.

With reference again to FIG. 1, after two half-box blanks 114 are produced, whether in series or in parallel, the two half-box blanks 114 are brought together at the gluing station 116. In accordance with embodiments of the present disclosure, the gluing station 116 includes a glue gun operable to dispense glue or some other bonding agent. In the gluing station 116, glue is dispensed to coat at least a portion of one side of a side flap 216, associated with one of the half-box blanks 114. This coated side flap 216 is then brought together or joined with a corresponding side flap 216 on the other half-box blank 114. Before bringing together the two corresponding side flaps 216 of the two half-boxes, glue or some other bonding agent may also be applied to the other side flap 216, so that both side flaps 216 have glue on at least one side of the flap, preferably the side that faces or comes into contact with the side flap 216 of the opposite half-box blank 114. The bonding agent (e.g., glue, epoxy, resin, cement or adhesive) may be applied to the side flap 216 in an engineered pattern coating, which is designed to provide support and bear load for the side flaps 216. The bonding agent is preferably spread over close to all, or substantially 100% of the side flap 216. A device other than, or in addition to, the glue gun may be used to achieve substantially 100% coverage including, for example, a sprayer, a roller, a nozzle, static, a glue roller and a flat edge (e.g., for evenly spreading the glue). The glue is preferably spread over a majority of one or both of the side flaps 216, and is more preferably close to or substantially 100% coverage. One having skill in the art will appreciate that the engineered pattern coating may be a grid-like coating or matrix pattern of bonding agent that is applied to one or both of the side flaps 216. One having skill in the art will also appreciate that a combination of a grid-like coating or matrix pattern and a smooth layer may be used to achieve the necessary strength in the bonding agent layer. The glue is preferably at a low viscosity during application to either or both side flaps 216. The glue is preferably elastic when dry, and is preferably a hot-melt glue with a relatively fast curing time. The hot melt glue preferably cures as its temperature drops. One having skill in the art will appreciate a preferable cure time based on the operational requirements of the box assembly system. One having skill in the art will also appreciate the methods used to accelerate curing of the glue including, for example, cooling the machinery at a point after the bonding agent is applied using liquid coolant (e.g., water), using compressed air, using solid-state coolers, or applying ultraviolet (UV) radiation.

In bringing together two half-box blanks 114, the corresponding side flaps 216 are glued together. This produces a box having four closed sides and two open sides, the open sides including end flaps 228 and dust flaps 224 of each half-box. Moreover, the two side flaps 216 forming opposite sides of the box 124 are composite box side portions, each comprising one side flap 216 of one of the half-box blanks 114, bonded to one side flap 216 of the other one of the half-box blanks 114.

In accordance with embodiments of the present invention, an amount of glue in excess of an amount required to join corresponding side flaps 216 of two half-box blanks 114 to one another is applied. In particular, excess glue can be applied at edges of the side flaps 216 near or adjacent the score lines 208 that generally define the ends of the side flaps. In accordance with still further embodiments, the excess glue may be in the form of a caulk or filling agent having adhesive properties. Moreover, the glue or caulk can be pliable, to form a seal with an adjacent end flap 228 and/or dust flap 224, to seal the corners of the assembled box 124 when the ends of the box 124 are closed.

It is one aspect of the present disclosure that the paper or other substrate 106, 114 is held in tension in the longitudinal direction through the processes of gluing the side flaps 216. The paper or other substrate 106, 114 is preferably held in tension until the glue substantially cures. Tension may be maintained in the paper or substrate 106, 114 in the longitudinal direction using conventional methods including, for example, web handling equipment from the moment the paper or substrate 106 comes off the rolls 104 through the folding plows 112 and the gluing station 116. After the glue has cured or substantially cured, the tension in the longitudinal direction may be released.

It is another aspect of the present disclosure that the assembled paper or substrate may be cut to length in cutting station 120. One having skill in the art will appreciate the methods by which the paper or other substrate 106 may be cut, including, for example a blade, press, knife, rotary saw, band saw, reciprocating blade, laser and water jet.

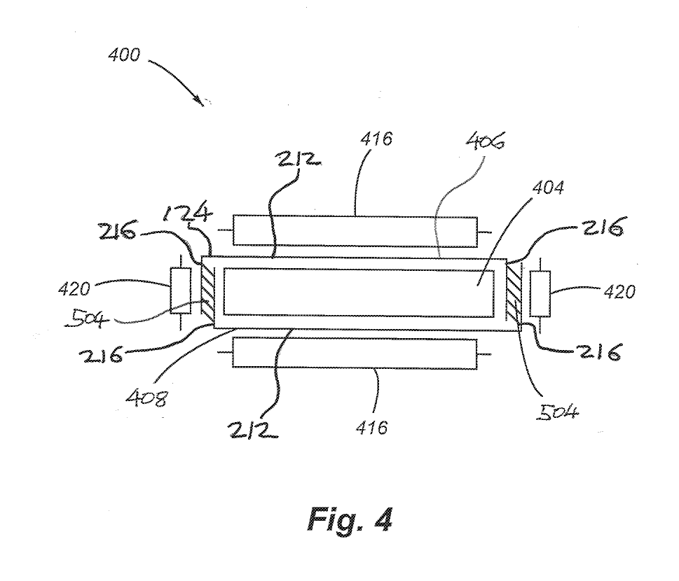

FIG. 4 shows a cross-sectional view 400 of a top half 406 and a bottom half 408 of the box 124 assembled with glue or some other bonding agent 504. As can be seen in FIG. 4, the top half 406 of the box shows the side flaps 216 depending downward from the top half 406 central section 212. The bottom half 408 of the box shows the side flaps 216 depending upward from the central section 212. More particularly, each side flap 216 of the top half 406 portion of the box 124 is interconnected to an adjacent or corresponding side flap 216 of the bottom half 408 portion of the box 124 by a bonding agent 412.

FIG. 4 shows an embodiment in which a box structure 404 is disposed inside of the assembled (but not completely closed) box. The box structure 404 is a guide upon which the half-box blanks 114 sit or are assembled around in the gluing station 116. The box structure 404 serves as a support that provides an opposing force to the top and bottom rollers 416 and side rollers 420. The box 124 is not glued to or otherwise permanently attached to the box structure 404, but the box structure 404 may be a stationary structure upon which the assembled box 124 slides as it is pulled by the rollers 416, 420. The force exerted on the assembled box 124 by the rollers 416, 420 provides tension to the webbing of the box 124 in the longitudinal direction during the gluing process. The side rollers 420 further serve to press the adjacent side flaps 216 together, causing the glue to spread evenly between the side flaps 216 and eliminate any voids that may be present. The figure shows the assembled box 124 having single-ply top and bottom sides and double-ply, composite or laminated side flaps 412. The attaching or gluing occurs on two side flaps 216 of the half-boxes, while the remaining two end flaps 228 and dust flaps 224 of the half-boxes are left unglued. Accordingly, an assembled box 124 is produced with an open front end and an open back end.

The side rollers 420 are shown with their axes substantially perpendicular to the longitudinal direction. In another embodiment of the present disclosure, the rollers may be rotated up to 90 degrees or oriented so that their axes are in a range between substantially perpendicular and substantially parallel to the longitudinal direction. The rotation or orientation of the side rollers 420 other than substantially perpendicular combined with the frictional force between the roller and substrate creates a tension in the side flap 216 in a direction other than longitudinal and in a direction that is oblique to the tension in the adjacent side flap 216.

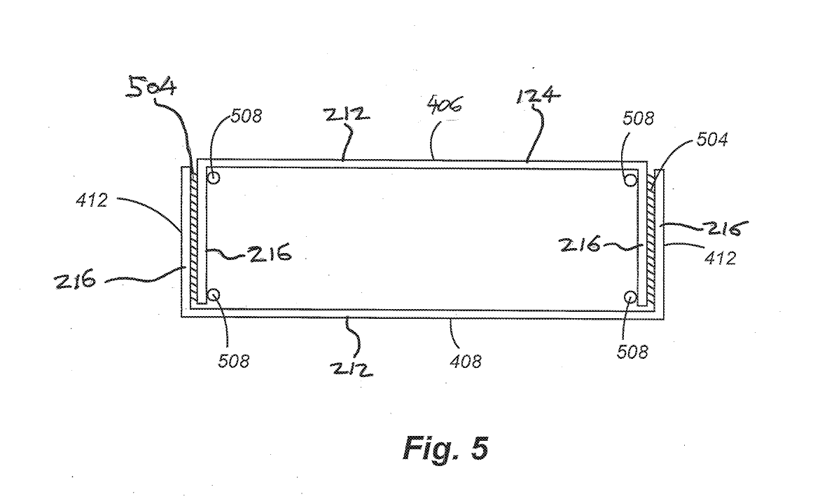

FIG. 5 shows a cross-sectional view of an assembled box 124. The figure illustrates the composite side flaps 412 of the box having overlapping side flaps 216, and having substantially 100% coverage (e.g., 100% coverage ±10%) of bonding agent 504 between the respective side flaps 216, to form the composite or laminated, double-ply or two-ply side flaps 412 of the box 124. The figure also illustrates that in the final box 124 configuration, the composite, double-ply side flap 412 has a thickness that is more than twice that of the thickness of a single side flap 216. The figure shows the box 124 having prongs or pins 508 located at the corners of the box 124. Before, during or after the assembled paper or substrate is cut to length in process 120, these prongs 508 are inserted into the hollow cavity on the inside of the box 124, and force is applied by the prongs 508 to provide tension around a periphery of the assembled box 124. For example, the applied force may be in a direction that is perpendicular to the creases defining the side flaps 216. One having skill in the art will appreciate the prongs 508 could be configured as four pins, two thin bars or a combination thereof that can slide in and out of the box corners without damaging the box.

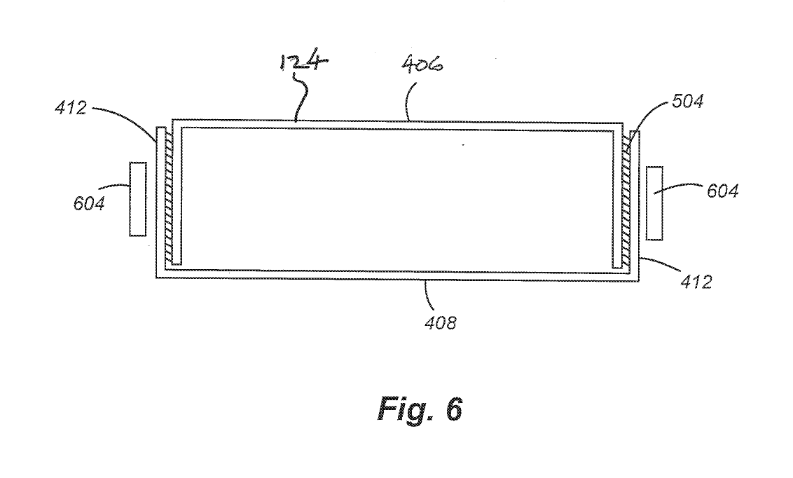

In an alternative embodiment, vacuum plates can be used to grasp (using a vacuum) the composite side flaps 412 of the box to provide perpendicular tension. FIG. 6 is a cross-sectional view of an assembled box 124 and illustrates how vacuum plates 604 can be positioned adjacent to the composite side flaps 412 of the box 124 to provide the desired tension to the box 124.

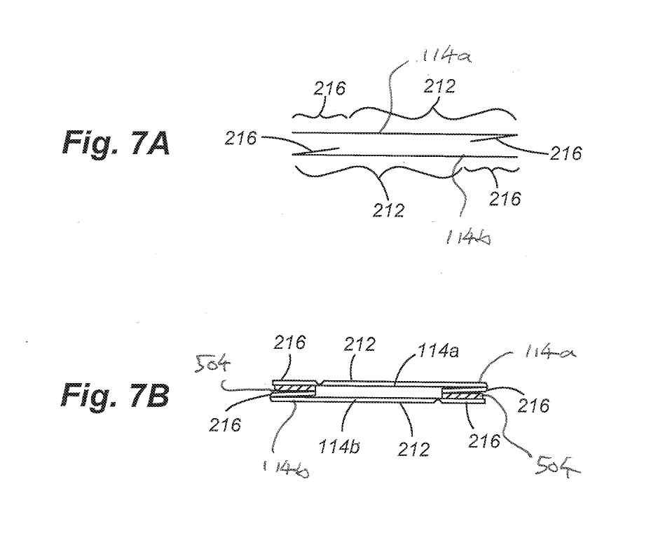

FIG. 7A, shows a cross-sectional view of two half-box blanks 114 of a box in accordance with embodiments of the present invention. Each half, a first or upper half 114a and a second or lower half 114b, has a central section 212 and two side flaps 216 that comprise the longitudinal sides of the box. In this embodiment of the present disclosure, only one of the side flaps 216 of a half-box blank 114 is folded over. As shown in the figure, one of the side flaps 216 of the top half-box blank 114 is folded over and one of the side flaps 216 of the bottom half-box blank 114 is folded over. The side flap 216 that is folded over is selected so that when the two halves are assembled, the folded over side flaps 216 are opposite each other. As described above, the upper and lower half-box blanks 114 are assembled in the gluing station 116, where glue or another bonding agent is applied as an engineered pattern coating on the surface of one or both opposing surfaces of the side flaps 216. As also described above, the two half-box blanks 114 are then brought together, and force is applied to bind the two halves together at the portions where glue has been applied. One having skill in the art will appreciate the methods that may be used to apply said force including, for example, a press, a roller disposed on either side of the flat box (either above or below), or more preferably two rollers disposed on both sides of the flat box (both above and below).

The result when the two half-box blanks 114 are assembled, as shown in FIG. 7B is a flat box assembly where at least one side flap 216 of a half-box blank 114 is substantially coplanar with the central section 212. In particular, the bonding agent 504 joins corresponding side flaps 216 of the two half-box blanks 114 to one another. As one having skill in the art will appreciate, the configuration illustrated in FIGS. 7A & B may be preferable for applications where the box does not immediately receive an item, and the assembled box is intended to be stored in a flat configuration for later expansion and use.

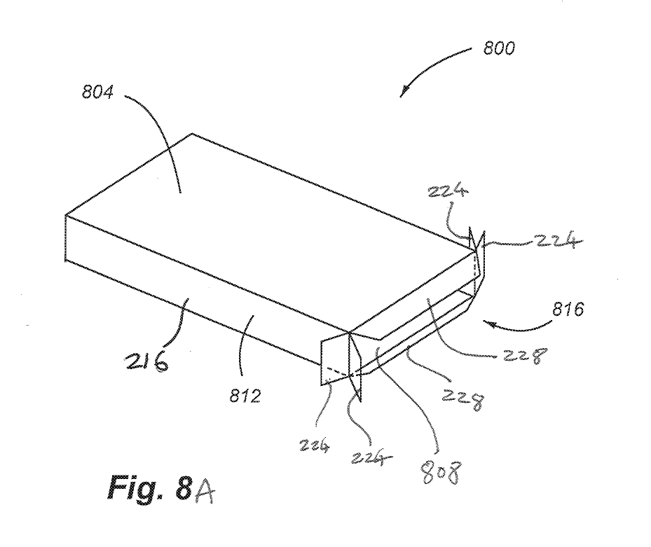

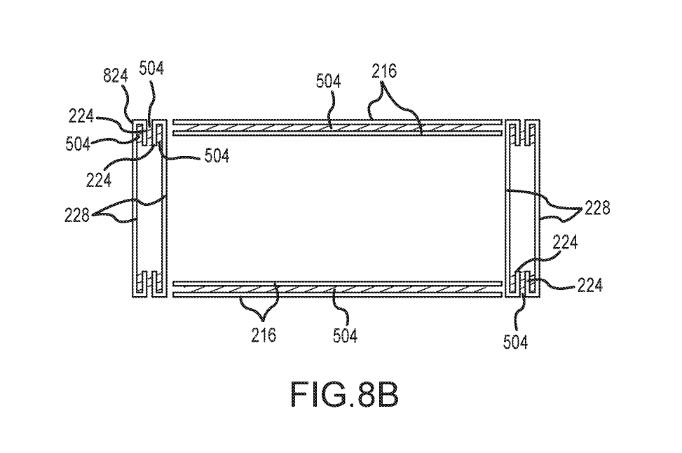

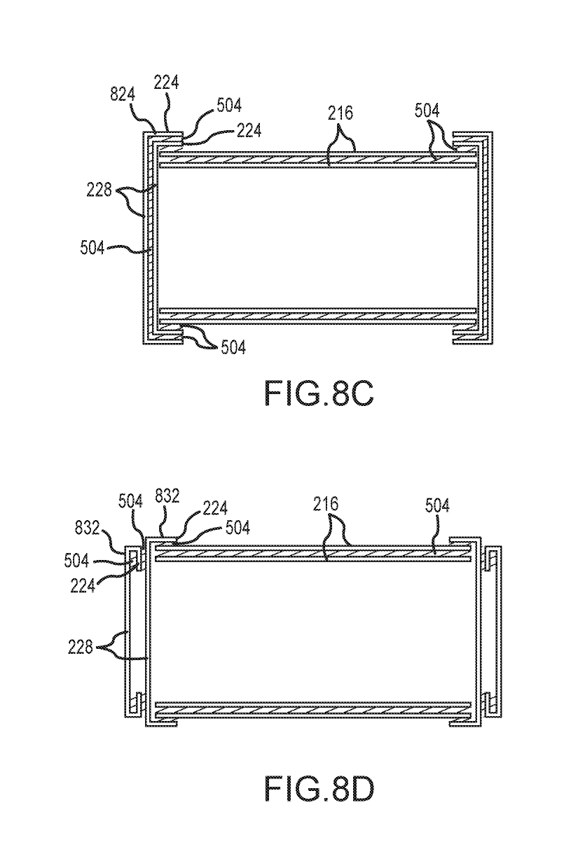

In FIG. 8A, an assembled box 800, in accordance with embodiments of the present disclosure is shown. The assembled box 800 includes a top side 804 and a bottom side 808. As can be appreciated from the discussion above, the top side 804 and the bottom side 808 are single ply sides. The remaining four sides of the box 800 are double ply sides. It will be understood that the ends 816 will be double-ply upon closure. In particular, the box 800 includes two double-ply sides 812, one of which is visible in FIG. 8A. Additionally, the box 800 includes two ends 816, one of which is visible in FIG. 8A. The sides 812 are closed by the gluing process described above. In accordance with embodiments of the present disclosure, the ends 816 remain open and operable to receive items therethrough into the interior of the box 800. After items are received by or inserted into the box 800 through either of the two ends 816, one or both of the ends 816 of the box 800 may be closed and box may then be shipped, stored, etc., as needed. In another embodiment of the present disclosure, one of the ends 816 is closed before or substantially at the same time the box 800 receives items or payload. Thereafter, the remaining end 816 may be closed, and the box 800 and item assembly is then ready to be shipped, stored, etc., as needed. An end flap 228 of a half-box may be closed or assembled to a corresponding end flap 228 of a corresponding half-box using a glue gun operable to dispense glue. Once glue is applied to one or both facing sides of end flaps 228 (i.e., sides that are facing upon assembly), the flaps are brought together to bond them. The glue is preferably spread over close to all, or substantially 100% of the end flap 228. A device other than, or in addition to, the glue gun may be used to achieve substantially 100% coverage including, for example, a sprayer, a roller, a glue roller and a flat edge (e.g., for evenly spreading the glue).

In one embodiment of the present disclosure, the dust flaps 224 at a corner may both depend from the end flaps 228. In another embodiment, one dust flap 224 may depend from one of the end flaps 228, and the other dust flap 224 may depend from one of the side flaps 216. In yet another embodiment, the dust flaps 224 at a corner may both depend from the side flaps 216.

It is another aspect of the present disclosure that both dust flaps 224 at a corner of the box may be glued to one or both end flaps 228 at that corner. Specifically, glue or another bonding agent 504 may be applied to the dust flaps 224 with a glue gun or some other means, and the dust flaps 224 are then brought together with an end flap 228 and/or each other. Having the dust flaps 224 glued to one side of each corner provides substantial strength to the box, and improves the strength at the corners as the corners absorb impacts and bear much of the load of the box. One having skill in the art will appreciate that this aspect of the present disclosure creates a laminated four-ply portion 824 where the dust flaps 224 are glued to the end flaps 228. The portions of an end flap 228 not bonded to a dust flap 224 can be bonded to an adjacent end flap 228. This configuration is depicted in FIG. 8B, which depicts an assembled box 800 in a closed state in a cross-section taken along a plane parallel to and between the top 804 and bottom 808 sides of the box 800 (see FIG. 8A). In the embodiment illustrated in FIG. 8B, the dust flaps 224 all depend from the end flaps 228. As an alternative, the dust flaps 228 can all depend from the side flaps 216. In accordance with still other embodiments, some dust flaps 224 can depend from side flaps 216, and other dust flaps can depend from end flaps 228, in various combinations. In addition, the two-ply sides 812, formed from the lamination of adjacent side flaps 216 to one another with a bonding agent 504, are shown.

It is another aspect of the present disclosure that both dust flaps 224 at a corner of the box may be glued to an adjacent side flap 216, either directly or through the other dust flap 224 at the corner. Glue or another bonding agent 504 may be applied to the dust flaps 224 with a glue gun or some other means, and the dust flaps 224 are then brought together with a side flap 216 and/or each other. One having skill in the art will appreciate that this aspect of the present disclosure creates a laminated four-ply portion 824 where the dust flaps 224 are glued to the side flap 216. This configuration is illustrated in FIG. 8C, which depicts an assembled box 800 in a closed state in a cross-section taken along a plane parallel to and between the top 804 and bottom 808 sides of the box 800 (see FIG. 8A). In the embodiment illustrated in FIG. 8C, the dust flaps 224 all depend from the end flaps 228. As an alternative, the dust flaps 224 can all depend from side flaps 216. In accordance with still other embodiments, some dust flaps 224 can depend from side flaps 216, and other dust flaps can depend from end flaps 228, in various combinations.

It is yet another aspect of the present disclosure that one dust flap 224 at a corner can be glued to an end flap 228, while a second dust flap 224 at the same corner can be glued to a side flap 216. Glue 504 may be applied to the dust flaps 224 with a glue gun or some other means, and one dust flap 224 is then brought together with an end flap 228, while the other dust flap 224 is then brought together with a side flap 216 to effect attachment of the dust flaps 224. One having skill in the art will appreciate that this aspect of the present disclosure creates two adjacent laminated three-ply portions 832 at each corner of the box 800. One three-ply portion 832 is on or adjacent the side flap 216 where one dust flap 224 is glued to the side flap 216, and the other three-ply portion 832 is on or adjacent the end flap 228 where second dust flap 224 is glued to the end flap 228. This configuration is illustrated in FIG. 8D, which depicts an assembled box 800 in a closed state in a cross-section taken along a plane parallel to and between the top 804 and bottom 808 sides of the box 800 (see FIG. 8A). In the embodiment illustrated in FIG. 8D, one dust flap 224 at each corner depends from an end flap 228, while the other dust flap 224 at each corner depends from a side flap 216. In accordance with other embodiments, other combinations are possible. For example, all of the dust flaps 224 at a corner can depend from end flaps 228 or side flaps 216.

It is still yet another aspect of the present disclosure that only one dust flap 224 at a corner is glued to either an end flap 228 or a side flap 216. Glue 504 may be applied to the dust flap 224 with a glue gun or some other means, and the dust flap 224 is then brought together with one of an end flap 228 or a side flap 216 to effect assembly of the dust flap 224. One having skill in the art will appreciate that this aspect of the present disclosure creates one three-ply portion. The three-ply portion is on the side flap 216 or the end flap 228 where the dust flap 224 is glued to the corresponding side or end flap.

In the foregoing descriptions of dust flap 224 assembly, the glue applied to the dust flap 224 is preferably spread over close to all, or substantially 100% of the surface of the dust flap 224 that is to be bonded to the other dust flap 224, end flap 228 or side flap 216, and a device other than, or in addition to, the glue gun may be used to achieve substantially 100% coverage including, for example, a sprayer, a roller, a glue roller and a flat edge (e.g., for evenly spreading the glue).

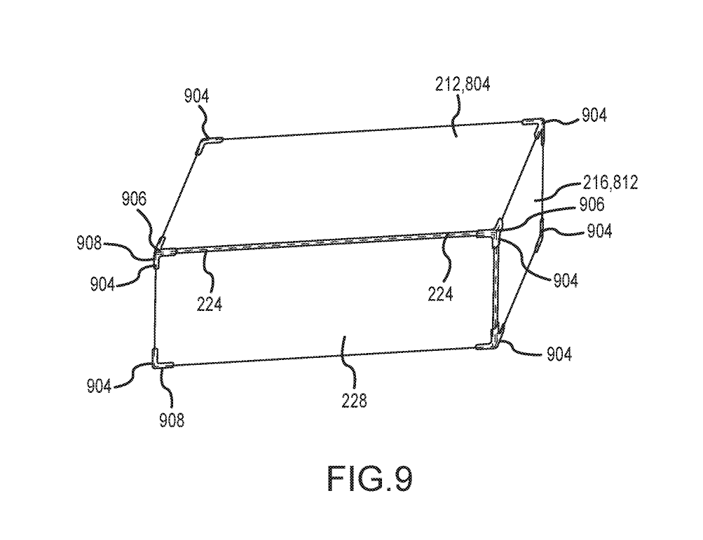

In various applications, it can be desirable to provide a box or container that is impervious to moisture. For such applications, embodiments of the present invention can include half-box blanks 114 comprising a top half 406 and a bottom half 408 that are formed from paper or other substrate 105 material that comprises or incorporates a moisture barrier. In accordance with further embodiments of the present invention, the substrate 105 can feature both structural and moisture blocking attributes. In order to provide a sealed enclosure, half-box blanks 114 formed from a moisture impermeable substrate 105 material can be combined with measures taken during the assembly of the box 124 to provide a complete seal against moisture. For example, as previously described herein, glue or adhesive 504 in excess of an amount needed to cover or substantially cover the surface of a side flap 216 can be applied, such that the excess amount covers any gaps that might occur at the corners of the assembled box 124. In accordance with still other embodiments, as illustrated in FIG. 9, a caulk or other sealant 904 can be applied at the corners 906 of the box 124 after an end of the box 124 adjacent the corners is closed. In accordance with still other embodiments, a sealant 904 can comprise a sealing member 908, in combination with a sealant or adhesive, can be applied to the corners 906 of the box 124. The sealing member 908 can, for example, comprise a corner member having three orthogonal surfaces on at least an interior section, that can be adhered to the box 124 to seal the box at the corner to which the sealing member is applied, and alternatively or in addition, to provide additional structural support to the box 124. In accordance with further embodiments, a sealant 904 applied to the corners 906 of the box 124 can comprise one or more pieces of moisture impermeable sheet material adhered to the corners 906 of the box 124. For example, the sealant 904 can be in the form of a waterproof tape.

In accordance with embodiments of the present disclosure, any suitable type paper may be used to manufacture a box in accordance with the disclosure. For example, size 7-8 Manila paper may be used. Additionally, paper that is less than 40 mils thick may be used to produce a box in accordance with embodiments of the present disclosure. The paper is preferably of a porous construction as this is more effective for bonding. Moreover, embodiments of the present disclosure do not require paper taken from paper rolls. In particular, sheets of pre-cut paper may be used to form each half-box.

In accordance with other embodiments of the present disclosure, the paper could be replaced by a film including, for example, PE, PET, PVC, PEEK or other polymer based films. It will be appreciated that when a non-fibrous or paper substrate is used, other chemical means may be used to bond the various sides, flaps, portions to other sides, flaps and portions. Additionally, techniques including, for example, ultrasonic welding may be used to bond the various sides, flaps, portions to other sides, flaps and portions.

In accordance with further embodiments of the present invention, a paper incorporating a moisture impermeable layer or layers can be used to manufacture a box in accordance with the present disclosure. For example, a poly coated (e.g., polypropylene coated) paper may comprise the substrate 105 used to form the half-box blanks 114 of a moisture impermeable box 124. As a further example, the substrate 105 can comprise an impermeable material that also provides stiffness. For example, the substrate 105 can comprise plastic or mylar.

A caulk or sealant 904 applied to the corners of an assembled and closed box 124 can comprise a silicon or other material capable of bonding to adjacent sections of the box halves 114, and of providing a barrier to moisture. Alternatively or in addition, a glue or filler applied, for example to the sides 216, ends 228 and/or dust flaps 224 of a box can comprise a seal that is impermeable to moisture.

In accordance with embodiments of the present disclosure, a printer may be used to print graphics, labels and/or other printed material on the continuous sheet of paper prior to the paper being cut, creased, folded, and otherwise processed by the various machine steps of the disclosure. The paper having a printed graphic may then be indexed prior to being cut, creased, folded, and otherwise processed by the various machine steps of the disclosure. One having skill in the art will appreciate that a printer may be inserted in the manufacture process at various points in the process including between the paper rolls 104 and the folding plow 112, between the folding plow 112 and the gluing station 116, between the gluing station 116 and the cutting station 120, and after the cutting station 120. A printer may also be integrated with another component, such as with a folding plow 112. One having skill in the art will appreciate that the aspect of the present disclosure that permits the use of a thin substrate permits flexibility in positioning the inline printer. Printer is meant to include single-pass or multi-pass single or multi-color apparatus, and may also include devices that apply engraving, carving, branding, stamping, embossing and watermark imprinting.

Retail boxes made in accordance with embodiments of the present disclosure are strong due to the presence of four double ply sides. The result of the two composite, double-ply sides 412 having substantially complete-coverage glue, is that its resulting composite wall strength of the box is more than the aggregate of the components. This allows boxes to be manufactured from thinner paper and/or other materials than is possible with conventional methods. Conventional methods use thicker substrates including paper, board, paperboard, corrugated fiberboard and containerboard. Accordingly, less material is used to make a box of the present disclosure than a conventional box of equivalent or greater strength. This leads to a less wasteful and more environmentally friendly product. In addition, the corners of the assembled box may feature three or four ply portions, to provide sealing and increased strength at the corners of the box. Although sometimes referred to herein as a retail box, a box created by a method or apparatus in accordance with embodiments of the present invention is not restricted to any particular application or use.

Retail boxes made in accordance with embodiments of the present disclosure from substrate 105 material that is impermeable to moisture, and that have been sealed at the corners 904 of the box 124, can be used as a container for goods or materials that are preferably protected from contact with the ambient air and/or moisture, at least during transport and/or storage. For example, food, such as cereals, grains, pastas, flour, sugar or other dry goods can be transported and stored in boxes 124 as disclosed herein. Moreover, separate inner liners or bags are not required in order to provide a complete seal against the entry of moisture and/or ambient air, or to prevent the leakage of the product out of the box 124. As further examples, items that are often packaged in a plastic tray or other structure for preventing or reducing crumbling, such as cookies and crackers, and then sealed in a bag, can be packaged in a box 124 in accordance with embodiments of the present invention. As can be appreciated by one of skill in the art after consideration of the present disclosure, embodiments of the present invention can therefore provide methods and systems for transporting and/or storing food or other items that are preferably sealed against moisture and/or the ambient environment, using less materials then other packaging techniques.

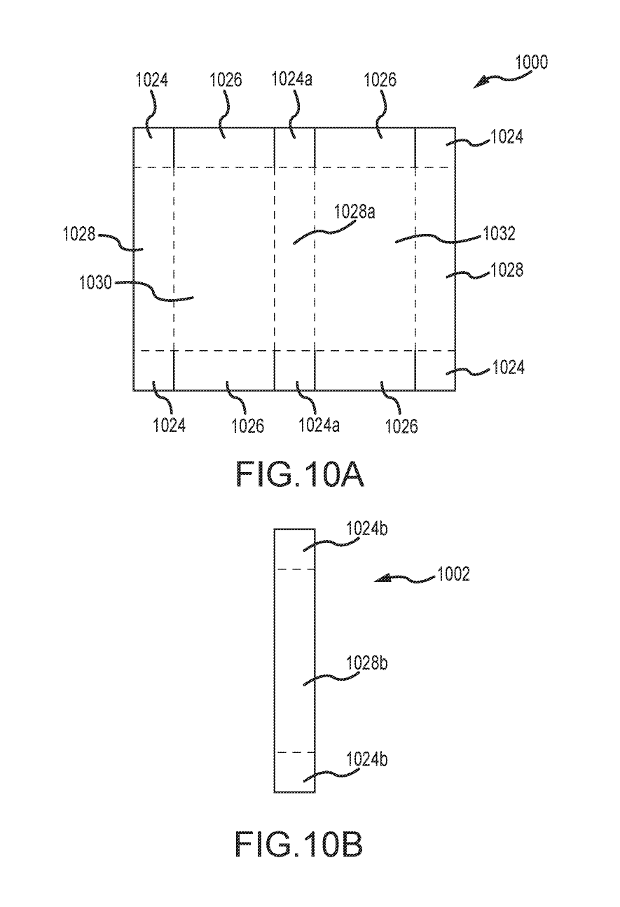

FIG. 10A illustrates a box blank 1000 in accordance with other embodiments of the present disclosure. The box blank 1000 may be single ply and comprise of six dust flaps 1024 (including central dust flaps 1024a), four end flaps 1026, three side panels 1028 (including central side panel 1028a), a top panel 1030, and a bottom panel 1032. The material for the box blank 1000 may be any suitable material, including but not limited to paper, cardboard, cardstock, treated paper, or the like. The solid lines illustrated in FIG. 10A depict cuts in the box blank 1000, while dashed lines indicate fold lines. FIG. 10B is an illustration of a side panel insert 1002. The side panel insert 1002 may be made of the same material or different material from the box blank 1000. The side panel insert 1002 comprises a side panel 1028b and two adjacent dust panels 1024b. The side panel insert 1002 may be the length of central side panel 1028a and the adjacent dust flaps 1024a, or may have a length or width that are slightly larger, within between about 100% to about 110% of the length or width of the central side flap 1028a and adjacent dust flaps 1024a. Stated another way, the area of the insert can be greater than the area of the portion of the blank that it is covering. For example the area of first insert can greater than the area of the first dust flap, second dust flap and side panel by between about 0% and about 10%, for any of these areas individually or in combination. The side panel insert 1002 may be attached or laminated to the central side flap 1028a and adjacent dust flaps 1028a with a bonding agent, including but not limited to glue, cement, tape, and the like. The bonding agent may cover at least about 50% of the central side panel 1028a and adjacent dust flaps 1024a and/or the side panel insert 1002. In accordance with further embodiments, the side panel 1028b may be attached to the central side panel 1028a, while its dust flaps 1028b remain detached to the central dust flaps 1024, at least until the box is assembled and closes.

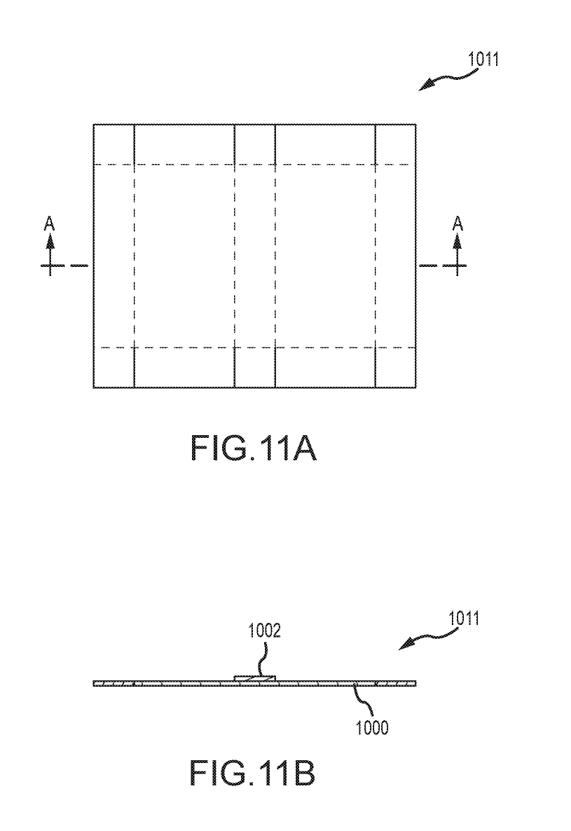

The box blank 1000 with the side panel insert 1002 attached is illustrated in FIG. 11A as 1011. The box blank 1011 may be shipped to the end user, where the end user may assemble and bond the side flaps to form a box assembly. In some embodiments, the box blank 1011 may be shipped to an end user to assemble the box. A cross sectional view of the box blank with the side panel insert 1011 is illustrated in FIG. 11B. The central panel of the box blank with the side panel insert 1011 is two ply, while the four of dust flaps 1024, four end flaps 1026, two of the side panels 1028, a top panel 1030, and a bottom panel 1032 are single ply.

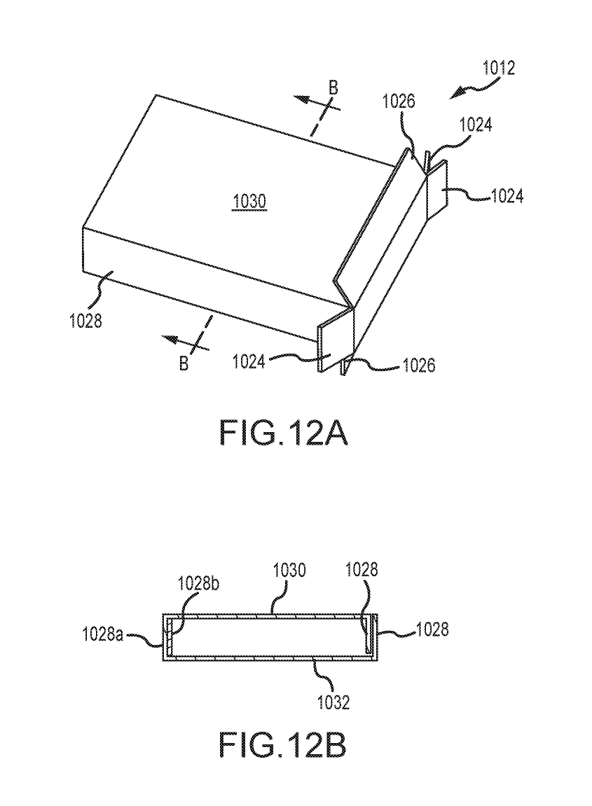

FIG. 12A is an illustration of an assembled box 1012. The box 1012 is assembled by attaching or laminating the two side flaps 1028 to each other. The resulting second side of the box 1228 is two ply. The bonding agent between the two side flaps 1028 may cover at least about 50% of at least one of the side flaps. Bonding agent may also be applied to the dust flaps 1024 to form two two-ply dust flaps.

FIG. 12B is a cross sectional view of the assemble box assembly 1012. The cross sectional view illustrates the side panel insert attached to the central side panel and the two side panels attached or laminated to each other.

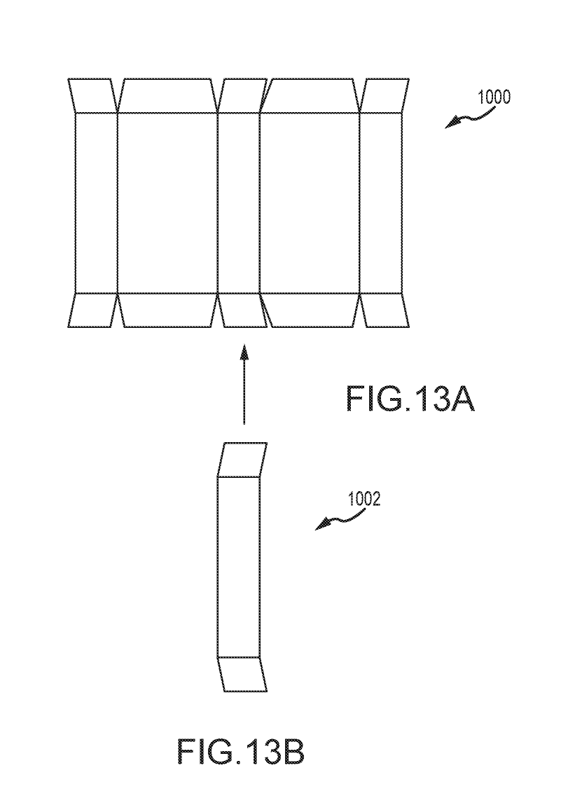

FIG. 13A illustrates the box blank 1000 with the cuts and folded along the dashed lines. FIG. 13 B illustrates the side panel insert 1002 folded along the dashed lines.

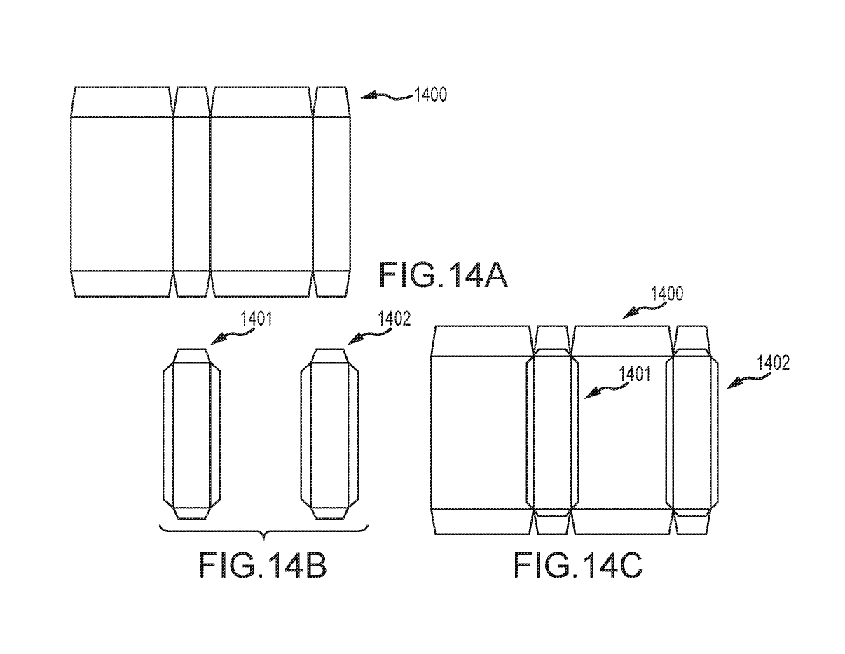

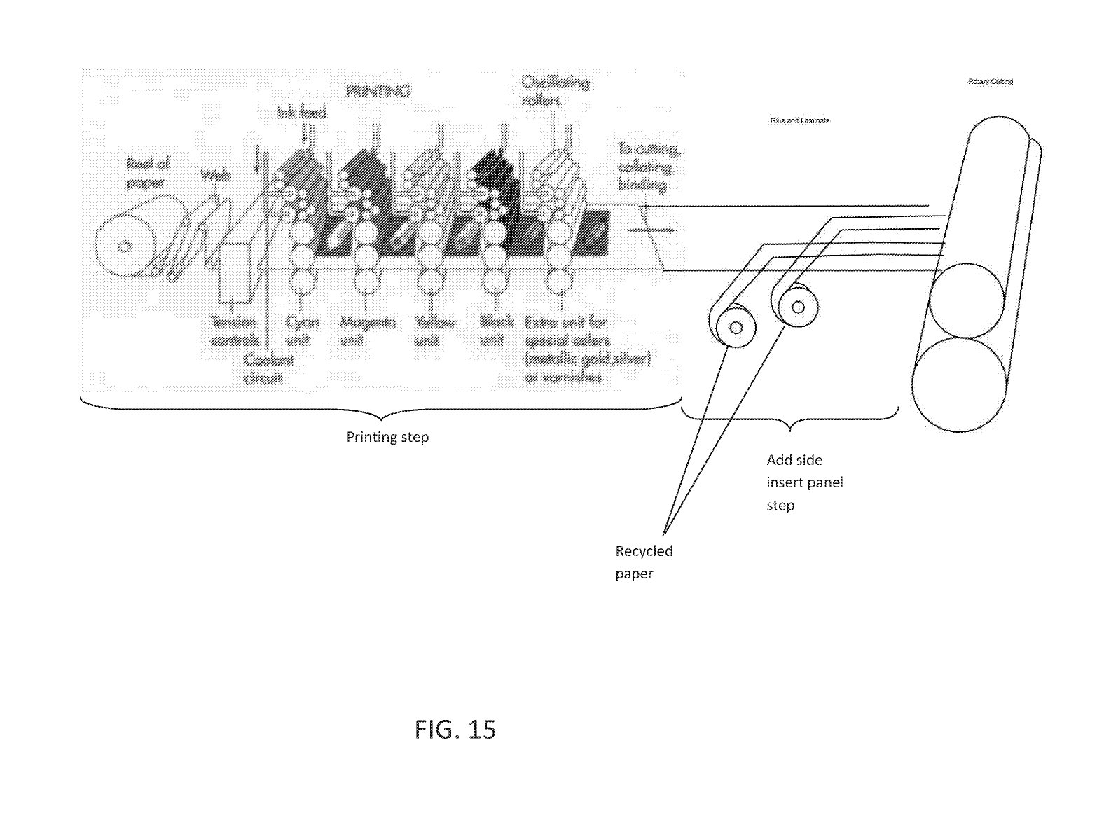

FIG. 14A illustrates a box blank 1400 illustrates a box blank of the invention. FIG. 14B illustrates two inserts 1401 and 1402. Insert 1401 and insert 1402 may be identical. FIG. 14C illustrates the box blank 1400 with the inserts 1401 and 1402 attached to the box blank. One skilled in the art would understand that the position of the inserts may be reversed on the box blank 1400. The box blank 1400 may be made of CRB board which has a glossy side for printing. The inserts may not be printed. Thus, while the inserts may be made of CRB board, the inserts may also be made with a material that does not require a glossy side for printing. Material that does not require a glossy side for printing may be cheaper material, thus reducing the cost associated with the box. Furthermore, the inserts may be approximately 16% of the total material of the combined box blank and the alternative insert material may reduce cost by about 50%. Therefore, an additional 8% in cost reductions could be possible.

Another aspect of the invention is a method for attaching the side panel insert to the box blank. The press, such as a web-fed offset press, can be used to connect the side insert panel to the box blank. Rotary technology, similar to that used in making offset printing work, can be utilized to register the insert at the correct location on the blank. The side insert panel can be added to one or both side panels. By way of example, the box blank may be printed, then the side panel inserts are added to the box blank on side panels and the dust flaps. The side panel inserts can be added to the box blank by any suitable method, including gluing or laminating. The glue can be applied in a pattern, be fully glued, cover the entire overlapping area between the side panel inserts and the box blank (over the side panels and dust flaps), or cover a portion of the area between the side panel inserts and the box blank. A vacuum roller or sheet cutting tool can be used to hold the glued insert in place on the blank until laminated. It is important to note that the side panel inserts can be attached to the box blank in a continuous process. Thus, the material that will eventually become the side insert panel can be a continuous sheet of paper attached to the box blank (before it is cut to size, but after it has been printed).

The material for the box blank can be any suitable material. In some embodiments, the box blank can be made of FDF board, recycled paper, CRB board, or the like. The thickness of the box blank can be between 12 caliber to about 20 caliber, in some embodiments about 14 calibers. The insert material can be any suitable material. In some embodiments, the insert material can be a paper board or a recycled paper. The source of the paper can be recycled paper bags. Other recycled paper materials can also be used. The insert material does not require pre-preparation to prepare the paper for printing, which can be at a lower cost than the box blank material.

After the insert is attached to the box blank, the box blank can have a thickness that is between about 5% and about 60% greater than a thickness of the reinforced box blank not comprising the insert. Thus, locations where the box blank is not reinforced with the insert can be thinner than areas where the insert is attached to the box blank. By way of nonlimiting example, the thickness of the box blank can be between about 3 and about 50 points. The thickness where the insert is present on the box blank can be between about 3 to about 50 points.

The side insert panels are attached to the box blank after it is printed, but before the box blank is cut to length or shape. A uniform box blank thickness allows for an efficient printing process. While it is possible for the printing press to accept varying box blanks with varying thicknesses, it would slow down the printing process and can cause failures when the box blank is fed through. Similarly, while it is possible for the side panel insert to be added to the box blank after the box blank is cut and sized, it would require a feed press capable of accepting a cut box blank with multiple flaps, which would increase the potential of failure for the feed of the box blank when the side panel attached to the cut box blank.

An advantage of the invention is that it reduces the material required to produce a reinforced box. The total material savings using the present method is between about 10 to about 40%, in some embodiments, about 25%. The cost saving using the present method can be between about 10% to about 35%, in some embodiments about 20%. An advantage of the method to attach the side panel insert to the box blank is that the process can be continuous, and in-line with other processes used to produce the box blank.

Another advantage is that the inserts provide two directions of strength—from front to back, and from top to bottom. By making the inserts slightly larger than the side panels on the box blank—so that it overlaps the area of the dust flaps and the top panel and the bottom panel—the strength of the box blank is increased in two directions. The amount of overlap can vary. In some embodiments, the overlap may be between about 0.1 inches and about 1 inch. In some embodiments, the overlap may cover between about 1% to about 20% of the dimension of the portion of the box panel it is covering. For example, the side panel insert may cover between about 1% to about 20% of the top panel. This added strength can be useful in not only packaging, but also in shipping the box blanks.

FIG. 15 illustrates a method to attach side panel inserts to the box blank. The reel of paper is sent through the printing step, where images and the like can be added to the box blank. Depending on the end configuration (i.e. whether only one side panel insert is added or if two side panel inserts are added), paper of the side panel insert is provided to the feed process. The paper of the side panel insert can be rolls of material, which can aid in the manufacturing process. The paper of the side panel insert positioned to be added to the box blank over the location of the side panels and dust flaps. Adhesive can be added to the paper of the side panel insert, to the box blank at the desired position, or to both the paper of the side panel insert and the box blank. After the paper of the side panel insert is added to the box blank, the box blank may be cut to size in a rotary cutter.

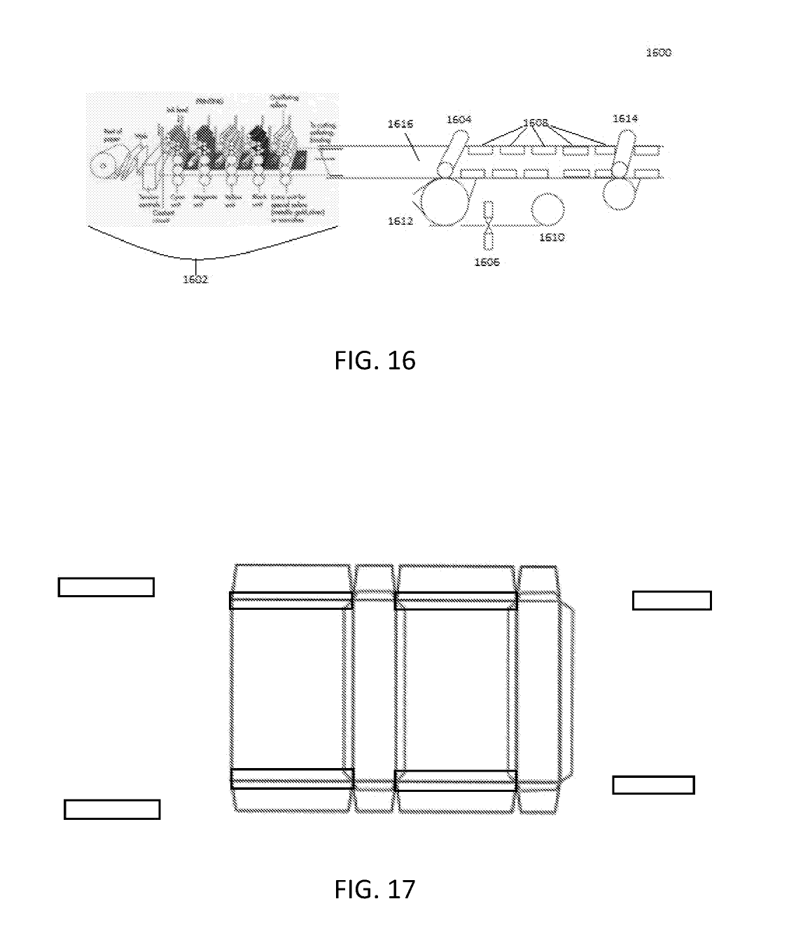

FIG. 16 illustrates a method and apparatus 1600 to attach the side panel inserts 1608 to a box blank 1616 utilizing a vacuum roller 1612. The box blank 1616 can be configured to run in either the machine direction or perpendicular to the machine direction. The blank 1616 can be preprinted in the printing station 1602 before the insert 1608 is attached to the blank 1616. The inserts 1608 can be prepared in line with the lamination process, or can be prepared separately and supplied to the lamination station 1604. FIG. 16 illustrates the inserts 1608 preparation in line with the lamination process. The insert 1608 are prepared by cutting a paper supply 1610, in a cutting device 1606, which can also provide glue to at least one portion on a side of the insert 1608. A lamination station 1604 attaches the insert 1608 to the blank 1616. A vacuum roller 1606 can be used to hold the insert in place during the lamination process. A cutting station 1604 can be used to cut the inserts 1608 after it has been attached to the blank 1616.

FIG. 17 illustrates a folding carton 1700 with end flap inserts applied between at least one end flap 1702A-D and the top panel 1704 or bottom panel 1706. These end flap inserts 1702A-D, when used with the side panel inserts 1708A-B, can strength the cartons strength in all three directions—front to back, top to bottom and side to side.

Cartons containing reinforced paper inserts have several advantages to non-reinforced cartons. First, the use of inserts significantly reduces the amount of board used to make most folding cartons with inserts, thereby making the use of inserts to reinforce cartons a sound business decision. By reducing the thickness of the folding carton by about 25-50% compared to load bearing material based non-reinforced cartons, the cost to produce the cartons is reduced by between 12-30%. Furthermore, the reinforced carton can be strengthened in two directions—from to back and top to bottom. This additional strength is important for products like cereal boxes that require side clamping. Cartons in general are weaker in the side to side direction, but this weakness is acceptable as there are not load bearing requirements in that direction. Furthermore, it is possible for the insert to be made of trimmings from wider master rolls of materials, or from low cost recycled papers (often used to make paper bags). Thus, the use of the inserts both reduces waste and can be manufactured at a low cost, which contributes to the advantages of using the inserts. Second, reinforced cartons have better properties, including strength, compared to non-reinforced cartons. Table 1 illustrates testing performed on reinforced cartons as compared to standard single layer cartons. As illustrated in Table 1, the strength of the reinforced carton is double that of the non-reinforced cartons. Thus, the insert can be made of a much thinner material, but still provide significant strength to the carton. Third, the process of manufacturing the inserts, and incorporating the inserts into the cartons can utilize an offset press.

TABLE 1

| | 223 Size Standard | | | 223 Size Reinforced Carton - | | |
|---|---|---|---|---|---|---|
| | Carton - 22 pt CRB | | | 16 pt CRB + 16 pt Inserts | | |
| | Direction | | | | | |
| | Front to | Top to | Side to | Front to | Top to | Side to |
| Test # | Back | Bottom | Side | Back | Bottom | Side |
| 1 | 110.286 | 63.316 | 126.808 | 226.578 | 120.321 | 53.658 |
| 2 | 103.862 | 66.484 | 117.128 | 225.618 | 125.434 | 58.498 |
| 3 | 108.284 | 62.326 | 127.864 | 247.038 | 126.455 | 52.25 |
| 4 | 108.746 | 63.184 | 115.39 | 202.554 | 128.453 | 62.26 |
| 5 | 106.876 | 65.868 | 121.374 | 226.512 | 122.879 | 59.84 |
| 6 | 109.626 | 62.26 | 110.968 | 205.37 | 130.683 | 58.3 |
| Average | 108 | 64 | 120 | 227 | 126 | 57 |
| % Change | 111% | 96% | −52% | — | — | — |
| compared to | | | | | | |
| reinforced | | | | | | |

The foregoing discussion of the disclosure has been presented for purposes of illustration and description. Further, the description is not intended to limit the invention to the form disclosed herein. Consequently, variations and modifications commensurate with the above teachings within the skill or knowledge of the relevant art are within the scope of the present disclosure. The embodiments described herein above are further intended to explain the best mode presently known of practicing the disclosure and to enable others skilled in the art to utilize the invention in such or in other embodiments and with the various modifications required by the particular application or use of the invention. It is intended that the appended claims be construed to include alternative embodiments to the extent permitted by the prior art.

What is claimed is:

1. A box blank, comprising:
a single ply blank, including:
a first side panel, a second side panel and a central side panel, wherein the first side panel, the second side panel and the central side panel each comprise a first end, a second end, a first side and a second side;
six dust flaps, wherein a first dust flap of the six dust flaps is dependent from a first end of a first side panel, a second dust flap of the six dust flaps is dependent from a first end of the central side panel, a third dust flap of the six dust flaps is dependent from a first end of the second side panel, a fourth dust flap of the six dust flaps is dependent from a second end of a first side panel, a fifth dust flap of the six dust flaps is dependent from a second end of the central side panel, a sixth dust flap of the six dust flaps is dependent from a second end of the second side panel;
a first end flap, a second end flap, a third end flap and a fourth end flap, wherein the first end flap, the second end flap, the third end flap and the fourth end flap each comprise a first end and a second end;
a top panel, comprising a first side, a second side, a first end and a second end, wherein the top panel is dependent on the first side of the top panel upon the second side of the first side panel, and the first side of the central side panel, a second side of the first end flap, and the first side of the second end flap; and
a bottom panel, comprising a first side, a second side, a first end and a second end, wherein the bottom panel is dependent on the second side of the central side panel and a first side of the second side panel, a second side of the third end flap, and the first side of the fourth end flap; and
a single ply side panel insert, including:
a first insert dust flap, and a second insert dust flap, wherein the first dust flap and the second insert dust flap each comprise a first end and a second end; and
a central insert side panel comprising a first end, and a second end, wherein a second end of the first insert dust flap is dependent upon the first end of the central insert side panel and wherein a first end of the second insert dust flap is dependent upon the second end of the central insert side panel, wherein an area of the first insert dust flap is greater than an area of the second dust flap of the six dust flaps and an area of the second insert dust flap is greater than an area of the fifth dust flap; and
a bonding agent, wherein a first layer of said bonding agent is situated between at least the central side panel of the single ply blank and the central insert side panel of the single ply side panel insert.

2. The box blank of claim 1, wherein the area of first insert dust flap is greater than the area of the first dust flap by between about 0% and about 10%.

3. The box blank of claim 1, wherein the area of the central insert side panel is between about 0% and about 10% greater than an area of the central side panel.

4. The box blank of claim 1, wherein a thickness of the single ply blank is between about 3 and about 50 points.

5. The box blank of claim 1, wherein a strength in a top to bottom or front to back direction of the box blank greater than a strength of a box blank in the same direction without the side panel insert.

6. The box blank of claim 1, further comprising at least one end panel insert.

7. The box blank of claim 6, wherein the at least one end panel insert overlaps the first end flap and the top panel.

8. The box blank of claim 1, further comprising four end panel inserts, wherein a first end panel inserts overlaps the first end flap and the top panel, a second end panel insert overlaps the second end flap and the top panel, a third end panel insert overlaps the third end flap and the bottom panel, and the fourth end panel insert overlaps the fourth end flap and the bottom panel.

9. A method to produce a reinforced box blank, comprising:
providing the box blank to a feed press;
providing at least one paper material source to a feed press, wherein the at least one paper material source is positioned on the feed press over a location of a side panel and two adjacent dust flaps;
providing an adhesive to at least one of the box blank over the location of the side panel and the two adjacent dust flaps, and the at least one paper material source; and
attaching an insert of the at least one paper material source to location of the side panel and the two adjacent dust flaps to produce the reinforced box blank, wherein at least one dimension of the insert is greater than at least one dimension of the side panel and the two adjacent dust flaps.

10. The method of claim 9, further comprising cutting the box blank to produce a cut box blank comprising the side panel, a second side panel, the two dust flaps, two second dust flaps, a top panel, a bottom panel, an end flap, a second end flap, a third end flap and a forth end flap.

11. The method of claim 9, further comprising attaching at least one end flap insert to the reinforced box blank.

12. The method of claim 11, wherein the at least one end flap insert is overlaps the first end flap and the top panel, the second end flap and the top panel, the third end flap and the bottom panel, or the fourth end flap and the bottom panel.

13. The method of claim 9, wherein the reinforced box blank comprising the insert has a thickness of between about 5% and about 60% greater than a thickness of the reinforced box blank not comprising the insert.

14. The method of claim 9, wherein a thickness of the box blank is between about 3 and about 50 points.

15. The method of claim 9, wherein the insert is between about 3 to about 50 points.

16. An folding carton, comprising:
a single ply blank, including:
a first side panel, a second side panel and a central side panel, wherein the first side panel, the second side panel and the central side panel each comprise a first end, a second end, a first side and a second side;
six dust flaps, wherein a first dust flap of the six dust flaps is dependent from a first end of a first side panel, a second dust flap of the six dust flaps is dependent from a first end of the central side panel, a third dust flap of the six dust flaps is dependent from a first end of the second side panel, a fourth dust flap of the six dust flaps is dependent from a second end of a first side panel, a fifth dust flap of the six dust flaps is dependent from a second end of the central side panel, a sixth dust flap of the six dust flaps is dependent from a second end of the second side panel;
a first end flap, a second end flap, a third end flap and a fourth end flap, wherein the first end flap, the second end flap, the third end flap and the fourth end flap each comprise a first end and a second end;
a top panel, comprising a first side, a second side, a first end and a second end, wherein the top panel is dependent on the first side of the top panel upon the second side of the first side panel, and the first side of the central side panel, a second side of the first end flap, and the first side of the second end flap; and
a bottom panel, comprising a first side, a second side, a first end and a second end, wherein the bottom panel is dependent on the second side of the central side panel and a first side of the second side panel, a second side of the third end flap, and the first side of the fourth end flap; and
a single ply side panel insert, including:
a first insert dust flap, and a second insert dust flap, wherein the first dust flap and the second insert dust flap each comprise a first end and a second end; and
a central insert side panel comprising a first end, and a second end, wherein a second end of the first insert dust flap is dependent upon the first end of the central insert side panel and wherein a first end of the second insert dust flap is dependent upon the second end of the central insert side panel, wherein an area of the first insert dust flap is greater than an area of the second dust flap of the six dust flaps and an area of the second insert dust flap is greater than an area of the fifth dust flap;
a bonding agent, wherein a first layer of said bonding agent is situated between at least the central side panel of the single ply blank and the central insert side panel of the single ply side panel insert, and wherein a second bonding layer is situated between a top side of the first side panel and a bottom side of the second side panel to form a folding carton.

17. The folding carton of claim 16, further comprising a bonding agent situated between at least a top side of the first end flap and a bottom side of the third end flap.

18. The folding carton of claim 16, further comprising a bonding agent situated between at least a top side of the second end flap and the bottom side of the fourth end flap.

19. The folding carton of claim 16, further comprising a bonding agent situated between at least one dust flap and the at least the top side of the second end flap and the bottom side flap of the forth end flap, to create a four ply thickness on at least one end of the folding carton.

20. The folding carton of claim 16, further comprising a bonding agent situated between at least one dust flap and the at least the top side of the second side panel and the bottom side of the at least one dust flap, to create at least a three ply thickness on at least side of the folding carton.
